(19) United States
(12) Patent Application Publication
(10) Pub. No.: US 2015/0302434 A1
(43) Pub. Date: Oct. 22, 2015

(54) System and method to measure brand favorability

(71) Applicant: Desikan Jagannathan, Los Altos, CA (US)

(72) Inventor: Desikan Jagannathan, Los Altos, CA (US)

(21) Appl. No.: 14/681,945

(22) Filed: Apr. 8, 2015

Related U.S. Application Data
(60) Provisional application No. 61/977,720, filed on Apr. 10, 2014.

(51) Int. Cl. G06Q 30/02

(52) U.S. Cl. CPC G06Q 30/0203; G06Q 30/0267

(57) ABSTRACT

A system and method to measure brand favorability is described. Brand advertising effectiveness has been traditionally measured using surveys, a technique that has well known limitations. This invention proposes a method called Ad Acknowledgment to gather user feedback, and AdAcknowledgment Rate as a direct measure of brand favorability. Acknowledgment requires no additional effort or attention from users, and enables census style brand favorability measurement that can scale to very large number of people.

### CROSS REFERENCE TO RELATED APPLICATION

This application claims priority of U.S. Provisional Application No. 61/977,720 filed on Apr. 10, 2014, titled “System and method to measure and improve brand favorability”, the contents of which are incorporated herein by reference in their entirety.

### BACKGROUND

1. Field of the Invention

This invention relates to a method of displaying brand advertisements to end users on Internet connected devices. More particularly, it is in the area of direct measurement of brand favorability and effectiveness of ad campaigns.

2. Background of the Invention

An advertisement (ad for short) in an Internet-connected device, be it a personal computer (PC), mobile phone or tablet, interrupts an end user's attention in screen space, time or both. For example, if we visit a site like Yahoo from a PC-based browser, we may see what are called display ads taking up screen space on top of the content (banner) as well as to the left (left column) and right (right column). Similarly, when we search at a site like Google, search ads relevant to the searched keywords may appear to the side of, or on top of search results. In either scheme, users are not stopped from content consumption unless they click on ads. Display ads on a mobile device work similarly. In a game app on a mobile phone for example, banner ads may take up 10% of the screen space on the top or bottom, and ads are refreshed frequently; game activity is not stopped unless a user clicks on an ad.

When a user clicks on an ad, the time component of the interruption kicks in. The user's content consumption stops and he or she is taken to the advertiser's website, an online store, an app store or some other call to action, which the user has to exit before going back to the original content site or app. Advertising that is bought and sold based on clicks is known as direct response advertising; its effectiveness is measured by Click Rates and its cost is measured using metrics like Cost-per-Click, Cost-per-Install and Cost-per-Conversion.

A large number of users have learned to tune out ads in general and display ads in particular—they rarely pay attention to these ads and almost never click on them. Interstitial ads were invented to mitigate this problem. An Interstitial ad is an image or rich media ad that has interruptive screen-space and time components. It suspends the users current activity, takes over the screen space completely for the ad and the user is forced to respond—he either waits until the ad closes after a fixed number of seconds, or he clicks on the Close button (usually a small image with letter X).

The purpose of brand advertising is to build awareness of the brand, increase favorability and purchase consideration. Users are not expected to take any immediate action, but it is hoped, for example, that they will remember the brand when they actually visit a store next time. In direct response advertising, business goals are directly measured by call to action metrics, and campaigns are optimized on that basis. Until now, there have been no good directly measured metrics for measuring effectiveness of brand advertising. Instead, brands use surveys from a small samples to gauge favorability, awareness etc. Online surveys start with a very large number of ads or invitations asking people to participate, and posing survey questions to people who accept the request. Surveys have a huge problem known as selection bias—where the types of people who take surveys are not representative of people in your target audience. If people studiously avoid ads, they are not likely to bother responding to an ad that asks for additional time to take a survey.

Finally, consumers are spending increasingly larger percentage shifting to mobile devices. The smaller screen size of these devices is changing the balance between space-interruptive and time-interruptive ads on them. Unlike a PC, the bias is towards time-interruptive ads that don't take up a percentage of limited screen space constantly. For brand advertisers, this further complicates measures of ad effectiveness.

### SUMMARY

The present invention makes possible census-style measurements of brand favorability. Census style advertising audience measurement incorporates response from every single person exposed to an ad. This is in contrast to survey-style audience measurement where only a small sample of the total population exposed to an ad takes the survey, and results are then extrapolated.

Metrics like Click-Through Rates, Click-to-Install Rates are census style measurements that work well for direct response advertising. Examples of this are keyword ads in search engine results or mobile ads from phone apps inviting you to install them. On the other hand, brand advertising is characterized by the Brand Funnel, which is an inverted pyramid with Awareness on top, followed by Favorability, Purchase Intent, Conversion, and Retention/Recommendation. There are no census style metrics for top levels of the Brand Funnel.

This fundamental difference between direct response and brand ads can be understood based on screen-space and time components of the ads themselves, and screen-space and time components of the interruption to the user for the ad to be deemed a success. In the case of direct response ads, the criteria for success matches the business goal—the user is interrupted in time from his current activity and taken to the advertiser's website or app when he clicks on the ad. In the case of brand ads, the business goal is to increase awareness and favorability, but these cannot be measured by clicks on the ad that takes you to the advertiser's website.

The present invention introduces a new method called Acknowledgement to brand advertising. The user is given the option to Acknowledge-and-close or just Close the brand ad, and either choice will close the ad and take the user back to immediately to the content or app he was looking at previously. Acknowledge-and-close is considered a positive response for the brand while just Close is considered neutral response.

This invention allows any time and screen space interruptive interstitial ad to be enhanced with additional user feedback elements—Close with Acknowledgment (required), Close (required) and More Options (optional)—and a mechanism for collecting data when a user clicks on these elements. The user has to click something to close the ad window anyway; acknowledgment allows them to do so with no further consequences, while still showing an appreciation for the brand that sponsored the free access to content they are seeing.

Acknowledgment-enhanced interstitial ads can be displayed just like traditional interstitial ads to any audience segment using AdServers, Ad Networks or Ad Exchanges. Mobile interstitial ad is the most compelling vehicle for Acknowledgment measurement as there is usually only one active window on the device at any time and the user will have to dispose of the ad one way or another to move on.

Facebook “Like” is ubiquitous on the Internet. But when you “Like” a brand on Facebook, it is permanent, your friends know about it, and the brand knows you liked them and may try to follow up with you later. Acknowledgment action of the present invention is designed to measure users' current feelings towards a brand in the aggregate only. It is guaranteed to be a transitory, one time action that is anonymous, and cannot be tracked back to individual users in any way.

Furthermore, the present invention proposes multiple embodiments of the Acknowledge method and proposes a system and method for collecting and aggregating acknowledgments and calculating AdAcknowledgment Rate, which is direct, census-style measurement of brand favorability.

Brand advertisers usually spend vast sums of money to design and simultaneously execute campaigns on multiple platforms, like TV, desktop/laptop computers and mobile phones/tablets. A key question they need an answer to is this: is the overall campaign across all platforms increasing brand favorability among audience segments of interest? AdAcknowledgment Rate can answer that question for brand advertisers with precision.

The present invention also proposes statistical models to correlate AdAcknowledgment Rate and related metrics with one or more other variables of business interest. AdAcknowledgment Rate can be continuously measured for a brand over extended periods of time; it can be calculated at the intersection of various end user dimensions, like geography, demographics and psychographics. AdAcknowledgment Rate and changes in the rate can be correlated with other variables along a time series. For example, we may establish a correlation between changes in Acknowledgment Rate in a given geography today with changes in actual product sales a few months from now in the same geography.

### BRIEF DESCRIPTION OF THE DRAWINGS

FIG. 1 is a block diagram illustrating a traditional interstitial ad and options for its disposition by the user.

FIG. 2 is a block diagram describing acknowledgement-enhanced interstitial ad in one embodiment of the invention.

FIG. 3 is a block diagram describing acknowledgment-enhanced interstitial ad with additional options.

FIG. 3A is a block diagram describing acknowledgment-enhanced interstitial ad with additional options, after the user clicks.

FIG. 4 is a block diagram describing acknowledgment-enhanced interstitial ad for head-to-head comparison of 2 different brands in one embodiment of the invention.

FIG. 5 is a block diagram illustrating a computing system for delivering acknowledgment enabled advertisements to end users and gathering data.

FIG. 6 is a flow chart describing the steps involved in collecting, processing and modeling acknowledgment data.

### DETAILED DESCRIPTION

Traditionally, ads are fully or partially screen-space interruptive and often time interruptive for the user. Any engagement with the ad by the user leads to additional space and time interruptions. Generally, the present invention makes possible Acknowledgment, a positive response to the brand portrayed in the ad in a way that does not lead to further screen space or time interruptions for the user. A user is allowed to Acknowledge the ad (a positive response) or Close the ad (a neutral response). By guaranteeing that either way he or she can get back to his content or app immediately, with zero additional space or time interruptions, this invention makes giving feedback effort-free for the user. This turns out to be particularly attractive to brand advertisers where any kind of repeatable user engagement with a brand ad is hard to come by.

Furthermore, Acknowledgment count, when divided by the number of times the ad was shown leads to the AdAcknowledgment Rate. In tests, AdAcknowledgment Rate is a direct, census-style measure of Brand Favorability.

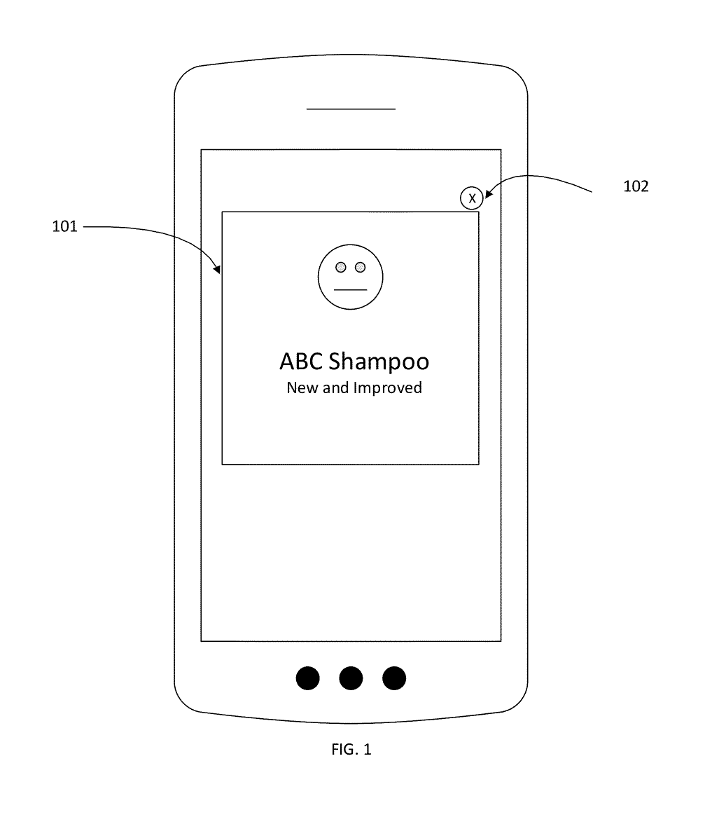

FIG. 1 illustrates a traditional interstitial ad. It is illustrated on a mobile device, but looks substantially same when content is accessed from a web browser in a desktop or laptop PC. When the ad creative (101) is displayed, user's view of the content or app is fully or partially blocked and the user cannot proceed further until he or she either clicks on the ad and takes him to the advertiser's website, or looks for the small X button (102) and clicks it to close the ad. When such ads show up, a vast majority of users immediately look for the X button to close the ad. On mobile devices with a small screen space, users trying to click on the X often accidentally click on the ad in what is called the fat-finger syndrome. Accidental clicks lead to frustrated users.

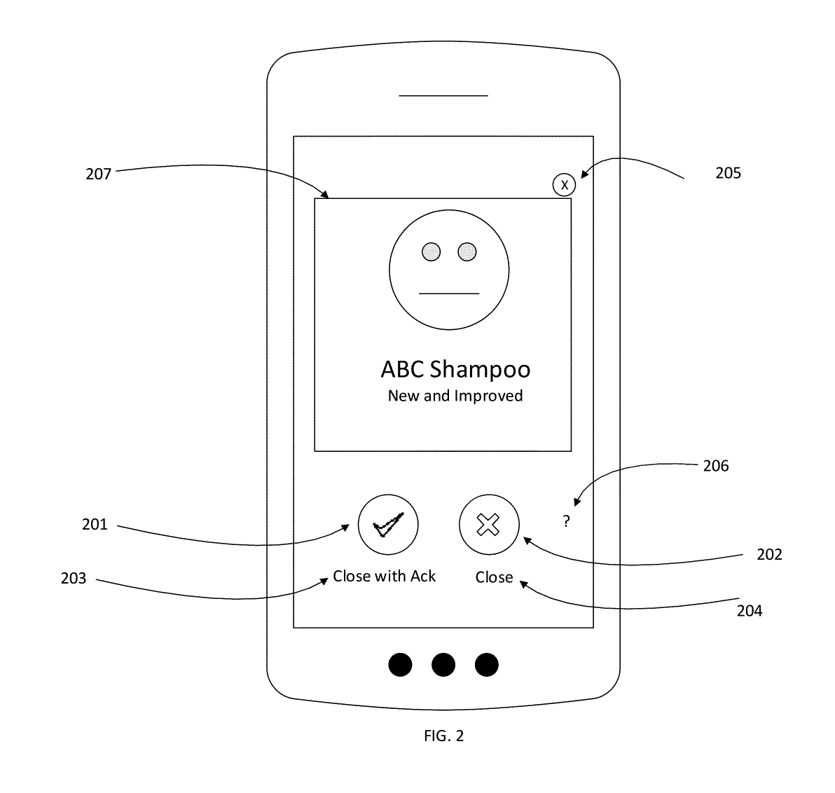

FIG. 2 illustrates a 2-button embodiment of the invention. It is shown on a mobile device, but looks substantially same when the ad is presented on web browser in a desktop or laptop PC. FIG. 2 shows an Interstitial ad creative (207) augmented with acknowledgment elements—the Acknowledge button (201) and the Close button (202)—as proposed by this invention. The text at the bottom of buttons, namely, Close with Ack (203) and Close (204) is optional, can be changed, and is there to make outcome of clicking them explicit. Clicking on either button closes the ad immediately and the user goes back to what he or she was doing before. 205 is the traditional Close button used by the ad industry and its use here is optional, as there is a large, easier to user interface element that does the same job. 206 is the Help element and clicking on it pops up a window with a brief description of Acknowledgment and a link for more information.

Since the effort needed for, and the outcome of clicking either 201 or 202 is exactly the same as far as the user is concerned, all friction in the process of a user giving an honest feedback about the brand is removed. Moreover, the feedback happens at the same moment the user is looking at the brand's ad image.

Acknowledgment data, gathered this way, leads to census style measurement of brand favorability, where an opinion is collected from every single user exposed to the ad. A benefit of this is that Brands can assess favorability at extremely fine levels of audience granularity. For example, a brand can study how its favorability numbers changed over the last 6 months for Females, 18-35, who use iPhones in the Peoria, Ill. metro area. Prior to this invention, brands have used surveys. Surveys are never concurrent with the ad exposure and are not good at giving granular results.

Most brand campaigns are cross-platform. A typical brand campaign may involve TV ads, magazine ads, display ads on a PC, or ads on a smartphone. Acknowledgment-based measurement of brand favorability on just one device, say a smartphone, is actually a cross-platform measure. A typical user acknowledges a brand based on his cumulative exposure across all platforms.

Through acknowledgment-enhancements, the present invention turns any traditional interstitial ad creative into a feedback-producing ad. There is no extra burden on the user either; he or she would have seen an ad anyway, and we just replaced a traditional ad with an acknowledgment-enhanced ad.

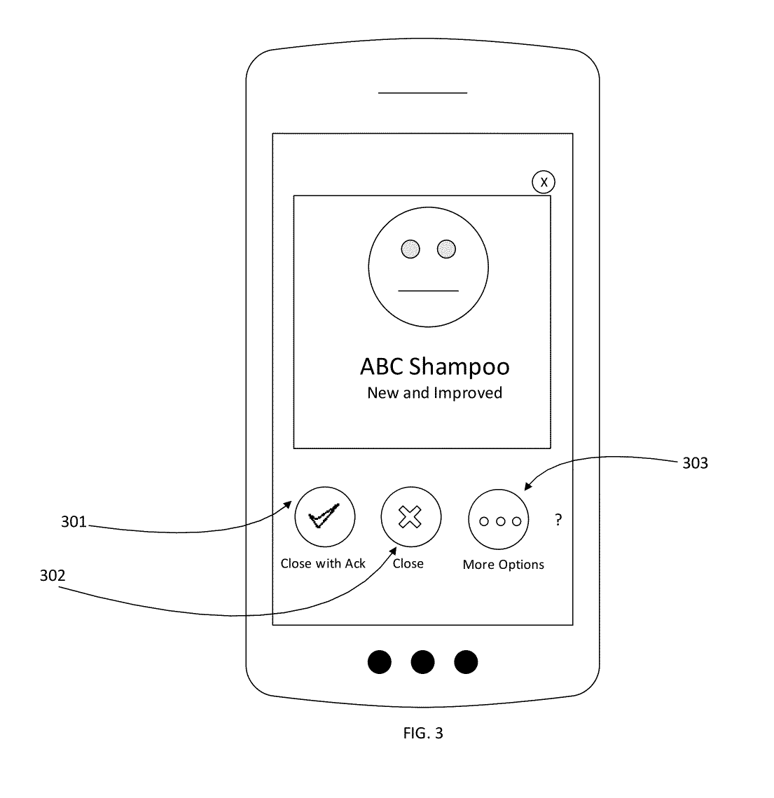

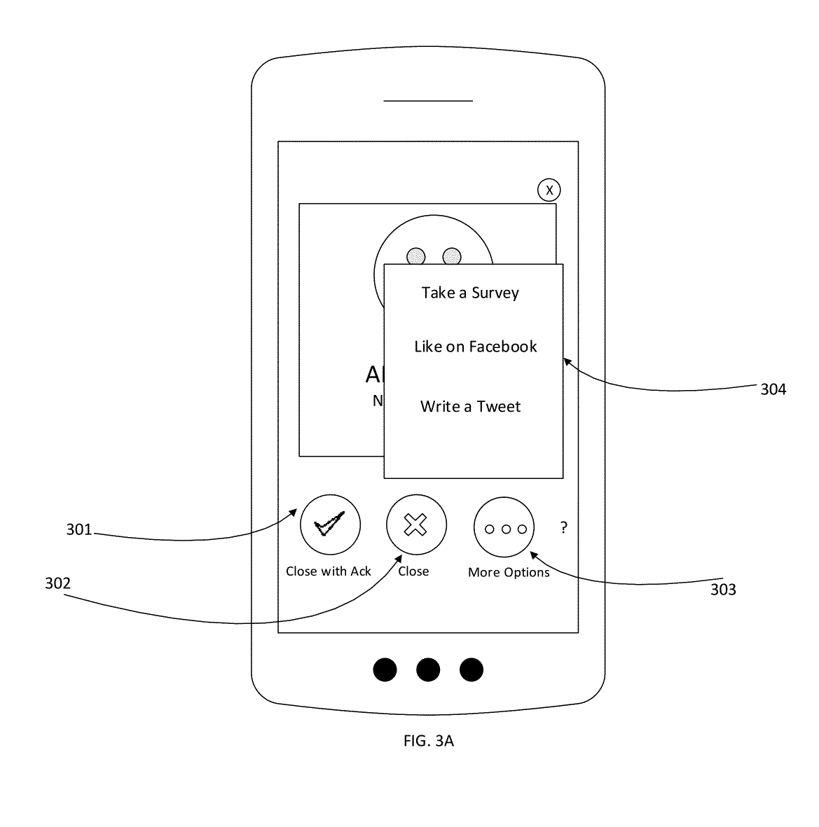

FIG. 3 illustrates the 3-button embodiment of the invention. Buttons 301, 302 work exactly the same way as buttons 201, 202 in FIG. 2. The third button (303), called More Options, enables the advertiser to package additional calls to action from the user.

FIG. 3A describes an example set of options (304) that pop up when the user clicks on the More Options button 303. More options allow the advertiser to track additional business goals and relate them to acknowledgment. Items in the list of 304 are not fixed and the list can be customized for each brand and/or ad. For example, the advertiser may use it to study the statistical relationship between acknowledgments and Facebook Likes in a user population.

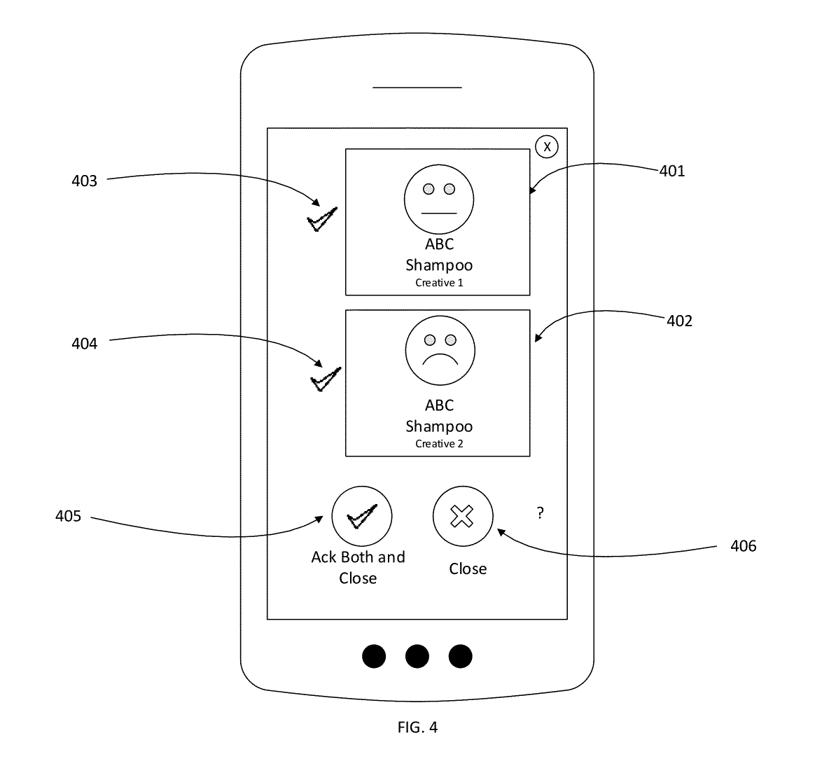

FIG. 4 illustrates relative-preference embodiment of the invention. This allows listing of two ad creatives (401 and 402) at the top and bottom halves of the ad space to enable head to head choice measurement. With a click of either 403 or 404, the user can acknowledge either ad individually. By clicking on Acknowledge Both (405), the user can acknowledge both ads, and by clicking Close (406), he can close without acknowledging either. All these clicks work the same way—they close the current ad and instantly return the screen to the content or app being viewed. This embodiment allows 2 creatives to be tested while they are both simultaneously visible to every user. A higher AdAcknowledgment Rate for a creative indicates preference for that by the audience segment of interest.

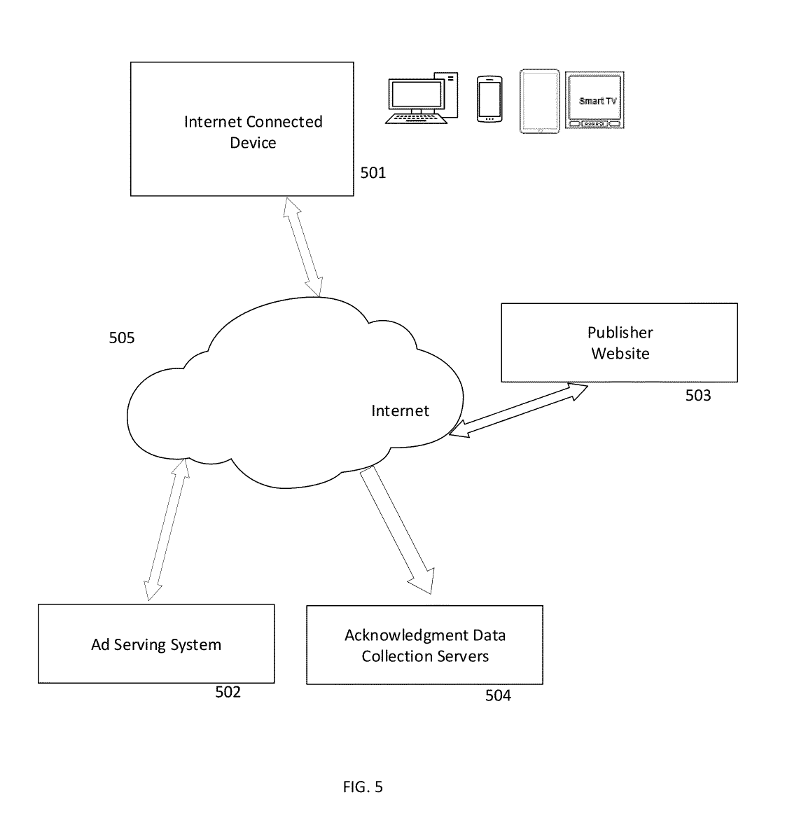

FIG. 5 describes a system that can measure brand favorability. It consists of one or more client devices (501), an ad serving system (502), publisher web server system (503) and Acknowledgment Data Collection systems (504) connected by a network (505). 502 holds acknowledgment-enhanced ad creatives, usually a combination of HTML and Javascript An app or a web browser on a client device (501) can request ads from ad serving system 502. Data about ad impressions, acknowledgments and closes is sent to Acknowledgment Data Collection System (504). Data in 504 is continuously aggregated along time and other dimensions to calculate AdAcknowledgment Rate and other metrics that measure brand favorability.

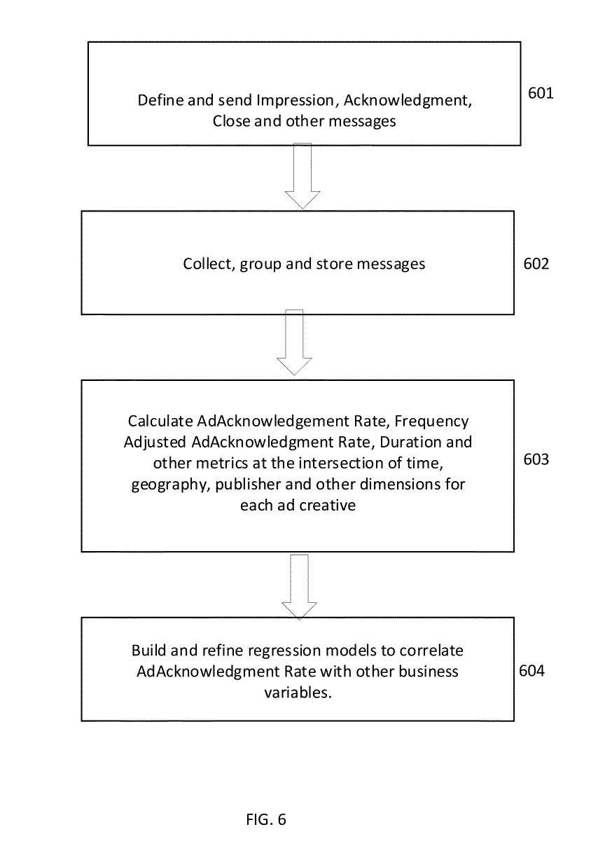

FIG. 6 is a flowchart representing the process by which brand favorability metrics are calculated and correlated with other business metrics. The present invention is a census-style measurement and as such it tracks every single ad impression and the user response to it. This is made possible by Javascript code that is added to the media creative to enable acknowledgment. When the creative is loaded and becomes viewable by the user, a message is sent on the Collection Servers (504). The messages can be sent to the server in a variety of ways, including a request with GET/POST web request (HTTP) parameters, or a message with parameters in the JSON format or any other format. JSON format example may look like this:

{....

“uid”: “ anonymous user id”,
“pubid” : “name or id of the app publisher or website”,
“contentid” : “name or id of the app or content currently viewed”,
“campname”:”name of the advertiser campaign”,
“creativename”:” name of the ad creative”,
“creativeurl” : “URL of the ad creative for tracking purposes”,
...
“action” : “show”

}

The “uid” refers to unique anonymous id of the client, which may be a cookie id on a browser on a PC device, Device ID or Advertising ID on current versions of iOS or Android. It doesn't matter what the identifier is, as long as it is reasonably unique to a particular device, but cannot contain any personally identifiable information.

Pubid, contentid, campname, creativename and creativeurl allow for grouping and aggregation of collected results. “action” refers to what type of message this is. “show” corresponds to initial visibility, “ack” corresponds to user acknowledging an ad, “close” corresponds to ad window being closed, “facebook” refers to the ad being liked on Facebook etc.

A message with action “show” is sent to Collection Servers (504) when the ad becomes visible to the user. Message with action “ack” or “close” is sent to Collection Servers when the user either acknowledges or closes the ad. When the user clicks on More Options and chooses an option, message is sent with action field set to that action.

Referring to FIG. 6, 601 encompasses creating messages with actions show, ack and close on client devices (501).

Step 602 describes collection, sorting and storage of such messages on Collection Servers (505).

Step 603 calculates AdAcknowledgment Rate and other metrics from messages stored by Collection Servers. For a given time period and a advertisement creative,

AdAcknowledgment Rate=(count of messages with Ack*100/count of messages with Show)

Similarly, for a given time period and advertisement creative,

Frequency Adjusted AdAcknowledgment Rate=(number of unique uids with Ack*100/number unique uids with Show)

This metric discounts multiple exposures of the ad to the same person.

AdAcknowledgment Rate can be calculated at the intersection of various other dimensions, like geographic area, device type and demographics.

AdAcknowledgment Rate is a direct measure of brand favorability. A brand advertising company can measure effectiveness of its cross-platform ad campaign by tracking changes in AdAcknowledgment Rate in subsequent time periods. By studying how it changes from time to time, brands can accurately gauge how their product is perceived in the market. By studying these metrics at extremely fine segments of their audience, brands can identify problems and put in place steps to fix them.

Referring to FIG. 6, Step 604 defines a process to model the correlation between AdAcknowledgment Rate and other business goals. For example, AdAcknowledgment Rate can be modeled as a leading indicator of sales using regression models of the form

$${SalesChange}_{t} = {β}_{0} + {\sum }_{k \geq 0} ( {α}_{k} {AdAcknowledgmentRate}_{t - k} ) + {ɛ}_{t}$$

where α is the regression coefficient, ε is the error term and k captures the lagging effect. This model is a time series correlation of percentage change in Sales during period t and AdAcknowledgment Rate in the prior k periods. For example, if a brand establishes that 15% AdAcknowledgment Rate as a steady state, any drop in the rate today is an indicator of potential drop in sales within the next k time periods.

### Patent Citations

| | Filing | Pub | | |
|---|---|---|---|---|
| Cited Patent | date | date | Applicant | Title |
| U.S. Pat. No. | Jul. 13, | Jan. 17, | comScore, | Analyzing effects of |
| 20,130,018,719 | 2012 | 2013 | Inc | advertising |
| U.S. Pat. No. | Jun. 27, | Feb. 6, | Rocket Fuel, | Inter-campaign |
| 20,140,040,008 | 2012 | 2014 | Inc. | advertising |
| | | | | management |
| U.S. Pat. No. | Feb. 7, | Mar. 20, | Dynamiclog- | System and method |
| 7,194,425 | 2006 | 2007 | ic, Inc. | for evaluating and/ |
| | | | | or monitoring |
| | | | | effectiveness of |
| | | | | online advertising |

1. A computer implemented method of measuring brand favorability comprising advertisements with user interface elements for user feedback, collection of feedback data and processing.

2. The method of claim 1 wherein the user can register feedback about the ad that is neither time interruptive nor screen-space interruptive.

3. The method of claim 1, wherein any traditional interstitial ad creative can be converted into a favorability feedback-producing ad by acknowledgment enhancements.

4. The method of claim 3 wherein the user has a choice of closing the ad with acknowledgment (a positive response) or just closing the ad (neutral response), with the guaranty that either choice will not require any additional effort, either choice will take the user back to his content or app immediately, and the action will be used for statistical purposes only.

5. The method of claim 3 wherein users are able to give true feedback about the brand because they have nothing to gain or lose in effort, attention or benefits, and acknowledgment is a completely anonymous operation.

6. The method of claim 1 wherein the user has a choice of closing the ad with acknowledgment (a positive response), just closing the ad (neutral response) or asking for more options (also a positive response). More-options button provides additional user actions that the advertiser makes possible selected ads.

7. The method of claim 1 where the user can indicate his choice between two creatives, in a head to head preference, while they both are simultaneously displayed.

8. The method of claim 1 where models can be built to establish correlation between AdAcknowledgment Rate and other business variables using time series and other regression models.

9. A system for delivering acknowledgment-enabled ads to users on various devices, collecting data on acknowledgments and calculating brand favorability metrics. The system comprising:
client devices for interacting with the user,
website of the content publisher,
one or more advertising servers,
acknowledgement data collection and processing servers.

10. The system of claim 9 wherein AdAcknowledgment Rate can be calculated as a direct measure of brand favorability.

11. The system of claim 9 wherein brand favorability can be measured on a census basis by showing acknowledgment-enabled to ads to as large or as small an audience segment as needed, and registering their response.

12. The system of claim 9 where changes in brand favorability can be measured to assess the effectiveness of a cross platform (TV, online or mobile) ad campaign by a brand advertiser
